(19) United States
(12) Patent Application Publication
(10) Pub. No.: US 2021/0332301 A1
(43) Pub. Date: Oct. 28, 2021

(54) A METHOD FOR THE PRODUCTION OF DIESEL

(71) Applicant: CDP Innovations Pty Ltd, Brisbane, Qld (AU)

(72) Inventors: Philip MAJOR, Brisbane, Qld (AU); Jimmy JIA, Brisbane, Qld (AU)

(21) Appl. No.: 16/625,408

(22) PCT Filed: Jun. 23, 2017
(86) PCT No.: PCT/AU2017/000137

§ 371 Date: Dec. 20, 2019

(30) Foreign Application Priority Data
Jun. 27, 2016 (AU) 2016902509

(51) Int. Cl. C10G 1/10; C10G 1/00; C10G 1/02; C10G 1/08; C10G 21/20; C10G 55/06; C10G 7/00

(52) U.S. Cl. CPC C10G 1/10; C10G 2300/44; C10G 1/02; C10G 1/083; C10G 1/086; C10G 21/20; C10G 55/06; C10G 7/00; C10G 2300/1011; C10G 2300/1003; C10G 2400/04; C10G 2300/4006; C10G 2300/202; C10G 2300/802; C10G 1/002

(57) ABSTRACT

A method for preparing feed material for a catalytic depolymerisation process, the method comprising the steps of: separating feedstock into two or more feedstock streams based on one or more properties of the feedstock, introducing each of the two or more feedstock streams into one or more process vessels, processing the feedstock streams in the presence of a catalyst in the process vessels under conditions of elevated temperature in order to produce two or more intermediate feedstock streams, and blending the two or more intermediate feedstock streams to form the feed material.

### TECHNICAL FIELD

The present invention relates to a method for the production of diesel. In particular, the present invention relates to a method for the production of diesel using a continuous catalytic depolymerisation method.

### BACKGROUND ART

For many years, alternative sources of hydrocarbon fuels to those produced from crude oil have been sought. The use of catalytic depolymerisation to convert hydrocarbon waste materials to hydrocarbon fuels has been put forward as one such alternative.

In a catalytic depolymerisation process (CDP), heat and catalysts are used to convert biomass and mineral based products (such as plastics) to a hydrocarbon fuel, such as diesel. However, existing CDP technology suffers from the drawback that the volumes of diesel produced are too small to achieve commercialisation of the technology. In addition, existing CDP technology is commonly prone to blockage and small dosing rates resulting in frequent interruptions in the production of hydrocarbon fuels. Further, competing technologies typically require the use of significantly elevated temperatures (in the order of greater than 450° C.) and pressures (typically, greater than atmospheric pressure) which are expensive to maintain and require the use of specialized equipment.

European patent application no. 1798274, for instance, describes a catalytic depolymerisation process. In this document, because of slow reaction times in the process vessels, a low efficiency pump is introduced into the circuit in order to increase residence time of material in the reaction chamber. By increasing the residence time in the reaction chamber, the volume of hydrocarbon fuels produced by the process is reduced, in turn severely limiting the ability of the process to be commercialised at a full-scale level.

Thus, there would be an advantage if it were possible to provide a catalytic depolymerisation method that allowed for the continuous production of hydrocarbon fuels at an increased rate.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a catalytic depolymerisation method, which may at least partially overcome at least one of the abovementioned disadvantages or provide the consumer with a useful or commercial choice.

With the foregoing in view, in a first aspect, the present invention resides broadly in a method for preparing feed material for a catalytic depolymerisation process, the method comprising the steps of: separating feedstock into two or more feedstock streams based on one or more properties of the feedstock, introducing each of the two or more feedstock streams into one or more process vessels, processing the feedstock streams in the presence of a catalyst in the process vessels under conditions of elevated temperature in order to produce two or more intermediate feedstock streams, and blending the two or more intermediate feedstock streams to form the feed material.

The feedstock may be of any suitable form. For instance, the feedstock may comprise biomass. Any suitable biomass may be used in the method such as, vegetable matter (including fruits, vegetables, pulses, grains, grasses etc.) or animal matter. The biomass may also comprise timber, paper, waste products (such as bagasse) and the like. Alternatively, the feedstock may comprise coal (or products derived therefrom), polymeric materials, such as plastic, rubber (synthetic and/or natural), or oils (including crude oil) and other materials derived from oil. In some embodiments of the invention, the feedstock comprises a mixture of biomass and polymeric materials. The feedstock may be liquid, solid or a combination of both.

Separation of the feedstock may be carried out based on any suitable property of the feedstock. For instance, the separation may be conducted based on the particle size of the feedstock, the density of the feedstock and so on. More preferably, the feedstock may be separated based on the type of material. For instance, in a preferred embodiment of the invention, the feedstock may be separated into a biomass feedstock stream and a polymeric material feedstock stream. If so desired, the polymeric material feedstock stream may be further separated into feedstock streams based on the type of polymeric material.

It will be understood that other feedstock streams may also be formed from the feedstock, such as an animal product feedstock stream, a timber feedstock stream, a rubber feedstock stream and so on.

The feedstock may be separated into feedstock streams using any suitable technique. For instance, the feedstock may be separated manually, or mechanically using any suitable sorting device. In an alternative embodiment of the invention, the feedstock may be obtained from different sources meaning that the feedstock may be pre-sorted into feedstock streams.

In some embodiments of the invention, the feedstock may be subject to a size reduction process prior to separation into feedstock streams. More preferably, however, the feedstock streams may be subject to a size reduction process prior to being introduced to the process vessels. The size reduction process may be conducted using any suitable size reduction technique. For instance, the feedstock streams may be crushed, ground, shredded, disintegrated, torn or the like, or any combination thereof. In some embodiments of the invention, the size reduction process comprises one or more size reduction devices. The size reduction devices may be of any suitable form, such as, but not limited to, a shredder, grinding mill, hammer mill, disintegrating mill or the like, or any suitable combination thereof.

Particles exiting the one or more size reduction devices may be introduced directly to the one or more process vessels. More preferably, however, particles exiting the one or more size reduction vessels may be separated on the basis of particle size, with particles below a predetermined particle size being introduced to the one or more process vessels or an intermediate storage vessel. Particles above a predetermined particle may be returned to the size reduction device or may be transferred to a secondary size reduction device in order to minimise the build-up of a recirculating load in the first size reduction devices (leading to a reduction in throughput).

The secondary size reduction device may be of any suitable form, and may include a shredder, grinding mill, hammer mill, disintegrating mill or the like, or any suitable combination thereof.

The particles may be separated on the basis of particle size using any suitable technique. Preferably, however, the particles are subject to a screening process, for instance using a vibrating screen deck, trommel or the like.

The feedstock streams introduced to the process vessels may be of any suitable particle size. It is envisaged, however, that relatively large particles may be introduced to the process vessels. Thus, in some embodiments of the invention, the particle size of the feedstock streams introduced to the process vessels may be up to about 20 mm. More preferably, the particle size of the feedstock streams introduced to the process vessels may be up to about 50 mm. Still more preferably, the particle size of the feedstock streams introduced to the process vessels may be up to about 200 mm. Even more preferably, the particle size of the feedstock streams introduced to the process vessels may be up to about 500 mm. Most preferably, the particle size of the feedstock streams introduced to the process vessels may be up to about 1000 mm. In a particular embodiment of the invention, the particle size of the feedstock streams introduced to the process vessels may be between about 20 mm and about 1000 mm.

This relatively large particle size provides the present invention with a number of advantages over the prior art. Firstly, prior art processes have typically required the particle size of the feedstock to be below 15 mm (and even below 5 mm), which requires significant (and costly) energy input into the size reduction devices to achieve. In addition, the reduction of feedstock to this relatively fine size create dust or could release hazardous or toxic substances from the feedstock which may pose a health risk to workers if inhaled or otherwise ingested. Further, finer particles could blow away, causing a loss of feedstock as well as a possible environmental impact. Finally, relatively fine particles may be prone to self-combustion during storage, leading to safety issues.

In some embodiments of the invention, the feedstock streams may be subject to an impurity removal process prior to their introduction to the process vessels. Any suitable impurities may be removed, although it is envisaged that the impurities to be removed may include any material that cannot be processed in the processing vessels. For example, the impurities may include inorganic materials, such as, but not limited to, metal, glass, rock and the like. In some embodiments of the invention metal impurities may be removed using one or more magnets.

The feedstock streams may be transferred directly to the process vessels. Alternatively, two or more storage vessels may be provided in which the two or more feedstock streams are stored prior to being introduced to the process vessels. Any suitable storage vessels may be used, such as one or more hoppers, silos, tanks, bunkers or the like, or any suitable combination thereof. Alternatively, the feedstock streams may be stored in heaps or mounds prior to being introduced to the process vessels.

The feedstock streams may be introduced to the process vessels using any suitable technique. For instance, the feedstock streams may be transferred manually (such as by using hand-held equipment including shovels or the like, or a vehicle such as bobcats, loaders, backhoes or he like, or any suitable combination thereof). Alternatively, the transfer of the feedstock streams to the process vessels may be carried out using conveyors, augers, feeders (such as vibrating feeders, apron feeders or the like) or similar equipment.

Preferably, the feedstock streams may be selected so that a relatively low-sulphur feed material is created by the blending of the intermediate feedstock streams to create the feed material.

In a preferred embodiment of the invention, each feedstock stream may be introduced to its own process vessel, or group of process vessels. For instance, a biomass feedstock stream may be introduced to one or more biomass feedstock stream processing vessels, while a polymer feedstock stream may be introduced to one or more polymer feedstock stream processing vessels.

It is envisaged that, in a preferred embodiment of the invention, more than one process vessel may be provided for each feedstock stream. However, not every process vessel may be in use at the same time. In addition, different process vessels may operate at different reaction rates in order to minimise the energy expenditure required to produce a substantially homogenous feed material.

In some embodiments of the invention, the feedstock streams may be introduced continuously to the process vessels. Alternatively, the feedstock streams may be introduced to the process vessels on an “as needs” basis (e.g. when the reserves of intermediate feedstock streams within the process are relatively low and new intermediate feedstock streams are required to maintain continuous operation of the process). In other embodiments, the feedstock streams may be introduced to the process vessels at predetermined intervals of time. The feedstock streams may be introduced to the process vessels at any suitable time intervals, and it will be understood that the time intervals will depend on the processing time of the feedstock streams in the process vessels, the capacity and throughput of the process and associated plant, the amount and type of feedstock available

One of the purposes of the present invention is to provide a continuous catalytic depolymerisation process. To achieve this, the feed material produced by the present method should ideally be substantially consistent, in terms of both the quantity of feed material produced and also the properties of the feed material produced (i.e. degree of solubilisation, size of residual solid material, degree of homogeneity etc.), so that the product produced from the feed material is of a consistent quality.

It is envisaged that a continuous process may be achieved by providing a plurality of process vessels for each of the feedstock streams. In this embodiment of the invention, one or more of the plurality of process vessels may be used for feedstock streams at different stages of processing. For instance, one or more process vessels may contain intermediate feedstock ready for blending, one or more process vessels may contain feedstock stream that is partway through its processing to form the intermediate feedstock, and one or more process vessels may contain fresh feedstock stream starting its processing to form the intermediate feedstock.

Thus, it is envisaged that there may be a continuous flow of each of the two or more intermediate feedstock materials for blending. More preferably, the ratio of the volume of each intermediate feedstock material to the other intermediate feedstock materials for blending is substantially constant at all times so as to form a consistent quality of feed material.

It will be understood that each of the feedstock streams may require processing in the process vessels for different periods of time to form the intermediate feedstock materials. Thus, it is envisaged that the different feedstock streams may be introduced to the process vessels at different rates in order to provide a consistent ratio of intermediate feedstock streams transferred to the mixing vessel. For instance, a feedstock stream that requires longer processing (residence) times in the process vessel may be introduced to the process vessels more often, or in greater quantities, than a feedstock stream that required shorter processing (residence) times in the process vessels.

In a specific example, a feedstock stream including polymeric materials may require a shorter processing time in the process vessel to form the intermediate feedstock stream than a feedstock stream comprising biomass. As a result, smaller quantities of the polymeric material feedstock stream may be introduced to the process vessels (or the feedstock stream may be introduced to the process vessels less frequently) in order to ensure that the desired ratio (or blend) of intermediate feedstock streams is blended to form the feed material.

The process vessels may be of any suitable size, shape or configuration, and may comprise a tank, reactor or the like. Preferably, however, the process vessels are agitated vessel. The process vessels may be of any suitable volume, although in a preferred embodiment of the invention, the process vessels may each have a capacity of up to 10,000 L. More preferably, the process vessels may each have a capacity of up to 5000 L. Yet more preferably, the process vessels may each have a capacity of up to 2500 L. It will be understood that the exact size of the process vessels will be dependent on the desired throughput for the process and the availability of feedstock. Thus, the size of process vessels may vary depending on these factors, or may be scaled upwardly or downwardly according to the availability of feedstock and so on.

The process vessels may be agitated using any suitable technique, such as one or more impellers. More preferably, however, the process vessels may be agitated using a recirculating pump. In some embodiments of the invention, the process vessels may be provided with one or more impellers in addition to a recirculating pump. It will be understood that the function of a recirculating pump is to extract material from the process vessel and then reintroduce it to the process vessel to cause agitation of the material within the process vessel.

Any suitable recirculating pump may be used, although in a preferred embodiment of the invention, the recirculating pump may comprise an inline mixer. The recirculating pump may extract material from any suitable location within the process vessel, although in a preferred embodiment, the recirculating pump may extract material from a lower region of the process vessel and reintroduce the extracted material into an upper region of the process vessel. In this way, relatively fine, light material that may float to the top of the process vessel may be drawn down into the process vessel and extracted through the bottom thereof so as to create a relatively homogenous intermediate feedstock stream.

The feedstock streams may be introduced to the process vessels using any suitable technique. Preferably, however, the feedstock streams may be introduced to the process vessels through the recirculating pump. The feedstock streams may be introduced to the process vessels by being blown or conveyed through a pipe in communication with the recirculating pump. Alternatively, the feedstock streams may be introduced to the process vessels under the Venturi effect, whereby the feedstock streams are entrained in the stream circulating through the recirculating pump.

In an alternative embodiment of the invention, a size reduction process prior to introducing the feedstock streams to the process vessels may not be required. In this embodiment of the invention, it is envisaged that the feedstock streams may be provided directly to the process vessels. In this embodiment, the feedstock may be provided in wet form (i.e. in a slurry) or as dry feed. The feedstock may be provided at any suitable particle size. For instance, the feedstock may be provided at a particle size of between about 20 mm and about 1000 mm, although it is envisaged that particles larger than this could be provided to the process vessels. More preferably, however, some size reduction may be used. In a preferred embodiment of the invention, the particle size in the feedstock may be up to about 300 mm. more preferably up to about 200 mm, still more preferably up to about 100 mm.

In some embodiments, the feedstock may be sorted into two or more feedstock streams prior to being introduced to the process vessels. A suitable sorting process has already been described earlier in this specification. In an alternative embodiment of the invention, the feedstock may be separated into a first feedstock stream containing relatively high sulphur content materials, and a second feedstock stream containing relatively low sulphur content materials. Each of the first and second feedstock streams may then be introduced to a different process vessel.

Alternatively, the feedstock may be introduced directly to the process vessels, such that the feedstock becomes a single feedstock stream introduced to the process vessels.

Thus, in a second aspect, the invention resides broadly in a method for preparing feed material for a catalytic depolymerisation process, the method comprising the steps of: introducing a feedstock stream into a process vessel, processing the feedstock stream in the presence of a medium in the process vessel consisting of an ionic liquid or mixture of ionic liquid in order to produce the feed material.

It will be understood that the purpose of the process vessels is to break down or solubilise the feedstock material so that the intermediate feedstock material produced in the process vessels is predominantly liquid (with residual solid particles). This may be achieved in a number of ways. Firstly, as previously mentioned, the recirculating pump may comprise an inline mixer, and it is envisaged that the inline mixer may assist in particle size reduction of the feedstock stream as it circulates therethrough. In addition, the inline mixer may assist in increasing the speed of the size reduction of the solid material in the feedstock streams.

Alternatively, the process vessel may be in the form of a gravity separation vessel, or a flotation cell. In this embodiment of the invention, it is envisaged that the feedstock may be introduced into the process vessel, preferably in the presence of a gas (such as, but not limited to nitrogen, oxygen, air or the like). In one embodiment of the invention, the gas may be provided in the form of a plurality of bubbles.

It is envisaged that, in this embodiment, some components of the feedstock (such as polymeric material) may be dissolved within the medium in the process vessel. Conversely, relatively heavy, dense components of the feedstock (such as metallic components) may precipitate or settle within the process vessel. In one embodiment, the precipitated or settled material may be in the form of a metallic sludge.

Preferably, the feedstock may be retained within the process vessel until such time as all dissolvable components in the feedstock have dissolved into the medium within the process vessel. The medium and the metallic sludge may then be removed from the process vessel and treated.

It is envisaged that the dissolved components of the feedstock may be used in the production of diesel, as well be discussed later in the specification. On the other hand, it is envisaged that the precipitated or settled components of the feedstock may be separated from any residual medium (which may be returned to the process vessel) and the metallic sludge may be processed using any suitable metal recovery technique or process.

While any suitable feedstock could be treated in the manner described, it is envisaged that, in one embodiment of the invention, the feedstock includes a mixture of polymeric material and metallic material (including metals, solder and the like). One example of such materials may include printed circuit boards (PCBs).

In some embodiments of the invention, the break down or solubilisation of the feedstock material may be achieved or enhanced so that the intermediate feedstock material produced in the process vessels is predominantly liquid is by operating the process vessel at an elevated temperature. Any elevated temperature may be used, although it is envisaged that the elevated temperature may be selected on the basis that the elevated temperature makes the solid particles in the feedstock streams more brittle or otherwise prone to size reduction (or solubilisation) in the process vessels. Any suitable elevated temperature may be used, although in a preferred embodiment of the invention, the elevated temperature may be between about 60° C. and about 500° C. More preferably, the elevated temperature may be between about 70° C. and about 350° C. Still more preferably, the elevated temperature may be between about 80° C. and about 230° C. Yet more preferably, the elevated temperature may be between about 90° C. and about 180° C. Even more preferably, the elevated temperature may be between about 100° C. and about 140° C. Most preferably, the elevated temperature may be about 110° C.

Furthermore, it is envisaged that, if present in the feedstock streams, liquid (particularly water) may be removed from the feedstock streams in the process vessels. Water may be removed by evaporation due to the elevated temperature in the process vessels. It is envisaged that water may be removed from the process vessels by being vented through one or more vents, columns, chimneys or the like. The water may be collected upon leaving the process vessels or may be released to the atmosphere as steam.

The process vessel may be maintained at the elevated temperature using any suitable technique. For instance, one or more heat sources (such as burners, heat probes or the like) may be used to maintain the process vessel at the elevated temperature. Alternatively, the feedstock streams may be introduced to the process vessel in the presence of a medium. In some embodiments of the invention, the medium may be heated to the elevated temperature. In further embodiments of the invention, the process vessels may be provided with a heating and/or cooling system. Any suitable system may be used, although in a particular embodiment of the invention it is envisaged that the process vessel may be at least partially surrounded by a jacket through which heating and/or cooling fluid may be circulated so as to control the temperature within the process vessel. Alternatively, heating and/or cooling fluid may be circulated through one or more pipes or jackets located within the process vessel so as to control the temperature therewithin. This exchange of heat may also result in increased energy efficiency within the method. Preferably, the heating and/or cooling fluid ensures that the process vessel is maintained at a substantially constant temperature, thereby maintaining an optimal environment within the process vessel for the reaction to take place.

In an alternative embodiment of the invention, one or more heat sources may be used to raise the temperature within the process vessel to the elevated temperature initially. However, it is envisaged that the reaction within the process vessel may be exothermic. Thus, in this embodiment of the invention, the reaction within the vessel may be sufficient to substantially maintain the elevated temperature within the process vessel. Alternatively, a heat source may be periodically required to be used to maintain the elevated temperature within the process vessel if the exothermic reaction within the process vessel does not generate enough heat to maintain the elevated temperature by itself.

Any suitable medium may be used in the process vessel. Preferably, however, the medium may be a liquid. More preferably, the medium may be an oil. In a specific embodiment of the invention, the medium may be a carrier oil. Preferably, the oil may be able to operate at temperatures below about 400° C. without substantial degradation so as to act as a heat transfer agent and also to minimise consumption of the oil within the process, particularly if the oil has a relatively high sulphur content.

Any suitable carrier oil may be used, such as, but not limited to, mineral oil, vegetable oil (canola oil, sunflower oil, castor oil or the like), nut oil and so on, or a combination thereof. In other embodiments of the invention, the carrier oil may include a petroleum oil, such as fuel oil, diesel, biodiesel or the like, or any suitable combination thereof.

In some embodiments of the invention, the carrier oil may assist in solubilising the solid material in the feedstock streams to form the intermediate feedstock streams. In other embodiments of the invention, one or more solvents may be added to the carrier oil in order to assist in solubilising the solid material in the feedstock streams. Any suitable solvent may be used, although in a preferred embodiment of the invention, the solvent may include methylimidazolium and/or pyridinium ions. Thus, in some embodiments of the invention, the catalyst may also act as a solvent.

In an alternative embodiment of the invention, the medium within the process vessels may consist of one or more ionic liquids. In this embodiment, the one or more ionic liquids may also comprise the catalyst. Any suitable ionic liquid may be used, although it is envisaged that the ionic liquid may comprise a liquid organic salt. The ionic liquid may preferably include methylimidazolium and/or pyridinium ions. One specific example of a suitable ionic liquid may be 1-Butyl-3-methylimidazolium chloride. It is envisaged that the ionic liquid may also act as a solvent. Thus, in a specific embodiment of the invention, it is envisaged that the ionic liquid (or mixture of ionic liquids) may comprise the totality of the medium within the process vessels, and may function as both solvent and catalyst.

There are a number of advantages to the use of ionic liquid (or a mixture of ionic liquids) as the medium in the process vessels. For instance, ionic liquids have no vapour pressure, create no pollution and have no odor. Ionic liquids are recyclable within the process, making the process both cost effective and with low waste generation. The process is non-destructive and has relatively low energy usage in comparison to prior art process. Finally, a significant advantage of the use of ionic liquid (or a mixture of ionic liquids) as the medium in the process vessels is the reduction of clogging in pipework within the plant due to the face that the intermediate feedstock streams produced in this manner are substantially free from solids (other than unavoidable trace amounts). Thus, the reliability and service life of equipment is improved, while downtime due to maintenance is reduced.

In another embodiment of the invention, the solid material in the feedstock streams may be further reduced in size by adding one or more size reduction members at or adjacent the point at which feedstock material is extracted from the process vessel and/or the point at which recirculated feedstock material is reintroduced to the process vessel. Any suitable size reduction members may be provided, such as one or more blades, teeth, grates, disintegrators or the like, or any suitable combination thereof. It is envisaged that the use of an inline mixer to recirculate the feedstock material may draw solid material in the process vessel into or through the size reduction members with sufficient force so as to cause breakage or disintegration of the solid material upon impact. Indeed, it is envisaged that the use of an inline mixer may create a vortex within the process vessel and assist in forming a substantially homogenous intermediate feedstock stream.

The process vessels may be open vessels or may be closed vessels. In a preferred embodiment of the invention, the process vessels are closed vessels. More preferably, the process vessels are adapted to substantially preclude certain gases from entering the process vessels. Specifically, the process vessels may be adapted to substantially preclude oxygen from entering the process vessels.

It will be understood that the mixing of oxygen with the intermediate feedstock stream may be undesirable given that the intermediate feedstock stream may comprise, at least in part, biodiesel or similar volatile substances. Mixing of such substances with oxygen may result in fire or an explosion.

In light of the foregoing, the process vessels may be provided with an airlock assembly adapted to substantially preclude oxygen from entering the process vessels. Any suitable airlock assembly may be required, including one or more valves (for instance, a double gate valve) through which the feedstock stream is added to the process vessel. The process vessel may be provided with an inert atmosphere (for instance, through the use of an inert gas, such as, but not limited to, nitrogen). In this embodiment of the invention, the pressure inside the process vessel may be elevated to greater than atmospheric pressure so as to minimise or preclude the flow of gases into the process vessel.

As previously mentioned, the processing of the feedstock streams in the process vessels is conducted in the presence of a catalyst. Any suitable catalyst may be used, and it is envisaged that the catalyst may be a liquid catalyst, a solid catalyst, or a combination of the two. The solid catalyst may be of any suitable form, although it is envisaged that the catalyst may comprise a powder. Preferably, the solid catalyst may comprise a strong base, such as (but not limited to) sodium hydroxide, potassium hydroxide, sodium methoxide or the like, or any suitable combination thereof. Alternatively, the solid catalyst may be a silicon-based catalyst or an aluminosilicate, such as a zeolite.

In embodiments of the invention in which the catalyst comprises a liquid, it is preferred that the liquid catalyst comprises, at least in part, an ionic liquid. Any suitable ionic liquid may be used, although it is envisaged that the ionic liquid may include methylimidazolium and/or pyridinium ions. It is envisaged that the ionic liquid may also act as a solvent.

The ionic liquid catalyst is preferably added by itself. Alternatively, the ionic liquid or may be mixed with another liquid prior to being introduced to the process vessel. Any suitable liquid may be mixed with the ionic liquid, although in a preferred embodiment of the invention, the ionic liquid may be mixed with a hydrocarbon liquid, such as, but not limited to, diesel or biodiesel. The hydrocarbon liquid and the ionic liquid may be mixed in any suitable proportions, and the hydrocarbon liquid may comprise between 1% and 99% of the mixture, while the ionic liquid may comprise between 1% and 99% of the mixture.

It will be understood that the amount of catalyst to be added to the process vessels may depend on a number of factors, including the type of material in the feedstock streams, the volume of the feedstock material and/or the process vessel, the type of catalyst, the temperature of the process vessel and so on.

It will also be understood that the purpose of the catalyst may be to solubilise the solid material in the feedstock stream through depolymerisation. It is envisaged that the catalytic reaction may not occur in the process vessels, but may occur during processing of the feed material to form diesel. Instead, the purpose of adding the catalyst to the process vessels may be to ensure the creation of a substantially homogenous feed material so that, the processing of the feed material to form diesel may be a relatively rapid reaction.

In some embodiments of the invention, a pH modifying substance may be added to the process vessels. It is envisaged that a higher, more basic pH in the process vessel may increase the solubilisation of the solid material in the feedstock streams, so that, in a preferred embodiment of the invention, the pH modifying substance may be a pH raising substance. Any suitable pH raising substance may be used, although in a preferred embodiment of the invention, the pH raising substance may be lime.

The pH of the material in the process vessel may be raised to any suitable pH. For instance, the pH in the process vessel may preferably be greater than 7. More preferably, the pH in the process vessel may be greater than 8. Still more preferably, the pH in the process vessel may be greater than 9. Even more preferably, the pH in the process vessel may be greater than 10. It will be noted, however, that the exact pH in the process vessel is not critical, provided that the pH is maintained in the range of between 8 and 12.

The catalyst and/or pH modifying substance may be added to the process vessel using any suitable technique. For instance, the catalyst and/or pH modifying substance may be added to the process vessel with the feedstock stream, or directly to the process vessel itself. More preferably, however, the catalyst and/or pH modifying substance may be added to the stream circulating through the recirculating pump. In this way, it is envisaged that the catalyst and/or pH modifying substance may be well-mixed into the recirculating stream as it re-enters the process vessel, thereby assisting with forming a homogenous intermediate feedstock stream. This stands in stark contrast to prior art techniques in which new feedstock material was added to material already undergoing processing in the process vessel. There was no method in the prior art to accurately dose the carrier oil with reagents or to disperse the reagents evenly through the mixture. The forming of a homogenous feed material in the present invention preferably increases the rate of reaction (and decreases residence time) due to improved contact between the reagents and the feedstock created by improved mixing.

The catalyst and/or pH modifying substance may be added to the recirculating stream at any suitable point. However, it is preferred that the catalyst and/or pH modifying substance may be added to the recirculating stream at a point between the outlet from the process vessel and the inlet of the recirculating pump. The catalyst and/or pH modifying substance may be added in any suitable way (for instance, by injection or the like). Alternatively, the catalyst and/or pH modifying substance may be drawn into the recirculating stream through a Venturi assembly or the like. Thus, in a preferred embodiment of the invention, the catalyst and/or pH modifying substance may be stored in a hopper, tank or feeder and the catalyst and/or pH modifying substance may be drawn into the recirculating stream from the hopper, tank or feeder through the Venturi assembly.

In embodiments of the invention in which the medium consists of an ionic liquid (or mixture of ionic liquids) it is envisaged that a plurality of process vessels may be provided for each feedstock stream. Preferably, the plurality of process vessels for each feedstock stream is operated in series. By this it is meant that a feedstock stream enters a first process vessel and is treated therein. A portion of the feedstock material is dissolved or digested in the ionic liquid, with the ionic liquid being withdrawn from the process vessel for further treatment after a period of time. Similarly, inorganic matter (including metallic components of the feedstock stream may precipitate or settle in the bottom of the process vessel.

It is envisaged that the precipitated or settled metallic components may be separated from any residual organic liquid using any suitable process (i.e. by evaporation of the ionic liquid, by filtration or the like). Preferably, the separated residual ionic liquid may be returned to the process vessel.

In this embodiment of the invention, it is envisaged that at least a portion of the hydrocarbon compounds present in the feedstock stream (or generated by the dissolution or digestion of the feedstock stream in the process vessel) may evaporate within the process vessel. In a preferred embodiment of the invention, evaporated hydrocarbons from a first process vessel maybe transferred to a second process vessel for further treatment.

In a preferred embodiment of the invention, the second process vessel may comprise an ionic liquid (or mixture of ionic liquids) having a density that is less than that of the ionic liquid (or mixture of ionic liquids) in the first process vessel. In this way, any inorganic material (such as metallic matter) entrained in the hydrocarbon stream entering the second process vessel that did precipitate or settle in the first process vessel may precipitate or settle in the second process vessel. Specifically, it is envisaged that materials having a density less than that of the ionic liquid in the first process vessel, but greater than that of the ionic liquid in the second process vessel will precipitate or settle in the second process vessel.

In some embodiments of the invention, the evaporated hydrocarbon stream leaving the first process vessel may be condensed prior to entering the second process vessel. The evaporated hydrocarbon stream may be condensed using any suitable technique, such as, but not limited to, the use of one of more condensers.

Any suitable number of process vessels may be provided in series, and it will be understood that the exact number of process vessels may be dependent on a number of factors, including the composition of the feedstock stream, the volume of the process vessels, the length of time for which the feedstock stream is treated in each process vessel, the type of ionic liquid used, the density of the ionic liquid in each process vessel and so on.

The intermediate feedstock streams may be blended at any suitable time. For instance, intermediate feedstock stream may be blended continuously from each of the process vessels. More preferably, however, the intermediate feedstock stream from a specific process vessel is blended when it forms a substantially homogenous mixture.

In light of the above, it is envisaged that each individual process vessel (or group of process vessels operated in series) may be operated in a batch process. That is, a feedstock stream may remain in a process vessel where it remains until it becomes a substantially homogenous mixture (in some embodiments, for instance, having solid particles of less than 1 mm in size) after which it is blended to form the feed material. The blending of the intermediate feedstock streams may be conducted in any suitable manner. For instance, the intermediate feedstock streams may be blended to form the feed material upon introduction to a reaction vessel. Alternatively, the intermediate feedstock streams may be mixed together in pipes leading to a reaction vessel so that a blended feed material is introduced to the reaction vessel.

In other embodiments of the invention, the intermediate feedstock streams may be introduced to an intermediate vessel for blending prior to introduction to the reaction vessel. Any suitable intermediate vessel may be provided, although in a preferred embodiment of the invention, the intermediate vessel comprises a mixing vessel. It is envisaged that the intermediate feedstock streams may be mixed together in the mixing vessel so as to form the feed material. From the mixing vessel, a continuous stream of feed material may be transferred to a reaction vessel where a catalytic depolymerisation process occurs. It is envisaged that the feed material will be of substantially consistent quality in order to facilitate relatively high volume production of diesel. However, as previously stated, it is envisaged that a plurality of process vessels may be provided for each feedstock stream, and the processing may be at different stages of completion in these process vessels. Thus, it is envisaged that there may be a continuous introduction of the intermediate feedstock stream from each plurality of process vessels associated with each feedstock stream.

The intermediate feedstock stream may be introduced to the mixing vessel using any suitable technique. Preferably, however, the intermediate feedstock stream is transferred from the process vessels to the mixing vessel using the recirculating pump. In this embodiment of the invention, it is envisaged that a valve may be provided on the pipe through which the recirculating material circulates, and actuation of the valve may transfer the intermediate feedstock stream to the mixing vessel rather than recirculating it to the process vessel.

Preferably, the intermediate feedstock stream comprises between about 10% and 50% solids. More preferably, the intermediate feedstock stream comprises between about 20% and 40% solids. Yet more preferably, the intermediate feedstock stream comprises between about 25% and 35% solids. Most preferably, the intermediate feedstock stream comprises about 30% solids.

In a preferred embodiment of the invention, the solids in the intermediate feedstock streams are no larger than about 10 mm. More preferably, the solids in the intermediate feedstock streams are no larger than about 5 mm. Still more preferably, the solids in the intermediate feedstock streams are no larger than about 2.5 mm. Most preferably, the solids in the intermediate feedstock streams are no larger than about 1 mm.

In other embodiments of the invention, the intermediate feedstock stream may be substantially free of solids (other than unavoidable trace amounts of solids).

The mixing vessel may be of any suitable form. In a preferred embodiment of the invention, however, the mixing vessel is, in many ways, similar to the process vessels. Specifically, it is envisaged that the mixing vessel may be agitated. The mixing vessel may be of any suitable volume, although in a preferred embodiment of the invention, the mixing vessel may have a capacity of up to 20,000 L. More preferably, the mixing vessel may have a capacity of up to 10,000 L. Yet more preferably, the mixing vessel may have a capacity of up to 5000 L. It will be understood that the exact size of the mixing vessel will be dependent on the desired throughput for the process and the availability of feedstock. Thus, the size of mixing vessel may vary depending on these factors, or may be scaled upwardly or downwardly according to the availability of feedstock and soon.

The mixing vessel may be agitated using any suitable technique, such as one or more impellers. More preferably, however, the mixing vessel may be agitated using a recirculating pump. In some embodiments of the invention, the mixing vessel may be provided with one or more impellers in addition to a recirculating pump. It will be understood that the function of a recirculating pump is to extract material from the mixing vessel and then reintroduce it to the mixing vessel to cause agitation of the material within the mixing vessel, thereby forming a substantially homogenous feed material.

Any suitable recirculating pump may be used, although in a preferred embodiment of the invention, the recirculating pump may comprise an inline mixer. The recirculating pump may extract material from any suitable location within the mixing vessel, although in a preferred embodiment, the recirculating pump may extract material from a lower region of the mixing vessel and reintroduce the extracted material into an upper region of the mixing vessel. In this way, relatively fine, light material that may float to the top of the mixing vessel may be drawn down into the process vessel and extracted through the bottom thereof so as to create a relatively homogenous feed material.

The intermediate feedstock streams may be introduced to the mixing vessel using any suitable technique. For instance, the intermediate feedstock streams may be introduced to the mixing vessel through the recirculating pump. Alternatively, the intermediate feedstock streams may simply be pumped into the mixing vessel through one or more pipes.

The mixing vessel may be operated at an elevated temperature. Any elevated temperature may be used, although it is envisaged that the elevated temperature may be selected on the basis that the elevated temperature makes any residual solid particles in the intermediate feedstock streams more brittle or otherwise prone to size reduction in the mixing vessel. Any suitable elevated temperature may be used, although in a preferred embodiment of the invention, the elevated temperature may be between about 60° C. and about 500° C. More preferably, the elevated temperature may be between about 70° C. and about 350° C. Still more preferably, the elevated temperature may be between about 80° C. and about 230° C. Yet more preferably, the elevated temperature may be between about 90° C. and about 180° C. Even more preferably, the elevated temperature may be between about 100° C. and about 140° C. Most preferably, the elevated temperature may be about 110° C.

The mixing vessel may be maintained at the elevated temperature using any suitable technique. For instance, one or more heat sources (such as burners, heat probes or the like) may be used to maintain the mixing vessel at the elevated temperature. In further embodiments of the invention, the mixing vessel may be provided with a heating and/or cooling system. Any suitable system may be used, although in a particular embodiment of the invention it is envisaged that the mixing vessel may be at least partially surrounded by a jacket through which heating and/or cooling fluid may be circulated so as to control the temperature within the mixing vessel. Alternatively, heating and/or cooling fluid may be circulated through one or more pipes or jackets located within the mixing vessel so as to control the temperature therewithin.

In another embodiment of the invention, the solid material in the intermediate feedstock streams may be further reduced in size by adding one or more size reduction members at or adjacent the point at which intermediate feedstock material is extracted from the mixing vessel and/or the point at which recirculated feedstock material is reintroduced to the mixing vessel. Any suitable size reduction members may be provided, such as one or more blades, teeth, grates, disintegrators or the like, or any suitable combination thereof. It is envisaged that the use of an inline mixer to recirculate the intermediate feedstock material may draw solid material in the mixing vessel into or through the size reduction members with sufficient force so as to cause breakage or disintegration of the solid material upon impact. Indeed, it is envisaged that the use of an inline mixer may create a vortex within the mixing vessel and assist in forming a substantially homogenous feed material.

The mixing vessel may be an open vessel or may be a closed vessel. In a preferred embodiment of the invention, the mixing vessel is a closed vessel. More preferably, the mixing vessel may be adapted to substantially preclude certain gases from entering the mixing vessel. Specifically, the mixing vessel may be adapted to substantially preclude oxygen from entering the mixing vessel.

It will be understood that the mixing of oxygen with the feed material may be undesirable given that the intermediate feed stream may comprise, at least in part, biodiesel or similar volatile substances. Mixing of such substances with oxygen may result in fire or an explosion.

In light of the foregoing, the mixing vessel may be provided with an airlock assembly adapted to substantially preclude oxygen from entering the mixing vessel. Any suitable airlock assembly may be required, including one or more valves (for instance, a double gate valve) through which the intermediate feedstock streams are added to the mixing vessel. The mixing vessel may be provided with an inert atmosphere (for instance, through the use of an inert gas, such as, but not limited to, nitrogen). In this embodiment of the invention, the pressure inside the mixing vessel may be elevated to greater than atmospheric pressure so as to minimise or preclude the flow of gases into the mixing vessel.

The mixing of the intermediate feedstock streams in the mixing vessel may be conducted in the presence of a catalyst. Any suitable catalyst may be used, and it is envisaged that the catalyst may be a liquid catalyst, a solid catalyst, or a combination of the two. The solid catalyst may be of any suitable form, although it is envisaged that the catalyst may comprise a powder. Preferably, the solid catalyst may comprise a strong base, such as (but not limited to) sodium hydroxide, potassium hydroxide, sodium methoxide or the like, or any suitable combination thereof. Alternatively, the solid catalyst may be a silicon-based catalyst or an aluminosilicate, such as a zeolite.

In embodiments of the invention in which the catalyst comprises a liquid, it is preferred that the liquid catalyst comprises, at least in part, an ionic liquid. Any suitable ionic liquid may be used, although it is envisaged that the ionic liquid may include methylimidazolium and/or pyridinium ions. It is envisaged that the ionic liquid may also act as a solvent.

The ionic liquid catalyst may be added by itself or may be mixed with another liquid prior to being introduced to the mixing vessel. Any suitable liquid may be mixed with the ionic liquid, although in a preferred embodiment of the invention, the ionic liquid may be mixed with a hydrocarbon liquid, such as, but not limited to, diesel or biodiesel. The hydrocarbon liquid and the ionic liquid may be mixed in any suitable proportions, and the hydrocarbon liquid may comprise between 1% and 99% of the mixture, while the ionic liquid may comprise between 1% and 99% of the mixture.

It will be understood that the amount of catalyst to be added to the mixing vessel may depend on a number of factors, including the type of material in the intermediate feedstock streams, the volume of the intermediate feedstock streams and/or the mixing vessel, the type of catalyst, the temperature of the mixing vessel and so on.

It will also be understood that the purpose of the catalyst may be to solubilise the solid material in the intermediate feedstock stream through depolymerisation. Thus, the reaction in the mixing vessel comprises a catalytic depolymerisation process.

In an alternative embodiment of the invention, no additional catalyst may be added to the mixing vessel. Instead, the contents of the mixing vessel may consist entirely of the intermediate feedstock streams. In this embodiment of the invention, it is envisaged that the intermediate feedstock streams may comprise substantially no solids (other than unavoidable trace amounts) meaning that the solubilisation or digestion of the organic components of the feedstock streams may be substantially complete. Thus, in this embodiment of the invention, the purpose of the mixing vessel may be only to create a substantially homogenous feed material by mixing the intermediate feedstock streams.

In particular, it is envisaged that the use of an ionic liquid (or combination of ionic liquids) as the totality of the medium in the process vessels may result in at least 80% recovery of inorganic material in the feedstock. More preferably, the use of an ionic liquid (or combination of ionic liquids) as the totality of the medium in the process vessels may result in at least 90% recovery of inorganic material in the feedstock. Yet more preferably, the use of an ionic liquid (or combination of ionic liquids) as the totality of the medium in the process vessels may result in at least 95% recovery of inorganic material in the feedstock. Still more preferably, the use of an ionic liquid (or combination of ionic liquids) as the totality of the medium in the process vessels may result in at least 99% recovery of inorganic material in the feedstock. Most preferably, the use of an ionic liquid (or combination of ionic liquids) as the totality of the medium in the process vessels may result in substantially 100% recovery of inorganic material in the feedstock.

In some embodiments of the invention, a pH modifying substance may be added to the mixing vessel. It is envisaged that a higher, more basic pH in the mixing vessel may increase the solubilisation of the solid material in the feedstock streams, so that, in a preferred embodiment of the invention, the pH modifying substance may be a pH raising substance. Any suitable pH raising substance may be used, although in a preferred embodiment of the invention, the pH raising substance may be lime.

The pH of the material in the mixing vessel may be raised to any suitable pH. For instance, the pH in the mixing vessel may preferably be greater than 7. More preferably, the pH in the mixing vessel may be greater than 8. Still more preferably, the pH in the mixing vessel may be greater than 9. Even more preferably, the pH in the mixing vessel may be greater than 10. It will be noted, however, that the exact pH in the mixing vessel is not critical, provided that the pH is maintained in the range of between 8 and 12.

The catalyst and/or pH modifying substance may be added to the mixing vessel using any suitable technique. For instance, the catalyst and/or pH modifying substance may be added to the mixing vessel with the intermediate feedstock stream, or directly to the mixing vessel itself. More preferably, however, the catalyst and/or pH modifying substance may be added to the stream circulating through the recirculating pump. In this way, it is envisaged that the catalyst and/or pH modifying substance may be well-mixed into the recirculating stream as it re-enters the mixing vessel, thereby assisting with forming a homogenous feed material.

The catalyst and/or pH modifying substance may be added to the recirculating stream at any suitable point. However, it is preferred that the catalyst and/or pH modifying substance may be added to the recirculating stream at a point between the outlet from the mixing vessel and the inlet of the recirculating pump. The catalyst and/or pH modifying substance may be added in any suitable way (for instance, by injection or the like). Alternatively, the catalyst and/or pH modifying substance may be drawn into the recirculating stream through a Venturi assembly or the like. Thus, in a preferred embodiment of the invention, the catalyst and/or pH modifying substance may be stored in a hopper, tank or feeder and the catalyst and/or pH modifying substance may be drawn into the recirculating stream from the hopper, tank or feeder through the Venturi assembly.

In some embodiments of the invention, a plurality of mixing vessel may be provided. A plurality of mixing vessels may be provided into which the intermediate feedstock streams may be introduced for blending. Alternatively, each intermediate feedstock stream may be introduced to a separate mixing vessel for mixing, and the blending of the intermediate feedstock streams may only occur in the reaction vessel, or during transfer of the intermediate feedstock streams to the reaction vessel.

Any suitable blend of intermediate feedstock streams may be used to form the feed material. In a preferred embodiment of the invention, however, the intermediate feedstock streams may be blended in a ratio of polymeric intermediate feedstock stream to biomass feedstock stream of between about 95:5 to 5:95. More preferably, the intermediate feedstock streams may be blended in a ratio of polymeric intermediate feedstock stream to biomass feedstock stream of between about 90:10 to 20:80. Still more preferably, the intermediate feedstock streams may be blended in a ratio of polymeric intermediate feedstock stream to biomass feedstock stream of between about 80:20 to 50:50. Yet more preferably, the intermediate feedstock streams may be blended in a ratio of polymeric intermediate feedstock stream to biomass feedstock stream of between about 75:25 to 35:65. Most preferably, the intermediate feedstock streams may be blended in a ratio of polymeric intermediate feedstock stream to biomass feedstock stream of about to 70:30.

In a third aspect, the invention resides broadly in a method for the production of diesel comprising the steps of: introducing a feed material into a reaction vessel, the reaction vessel being associated with one or more agitation devices adapted to agitate the feed material so as to ensure the substantial homogeneity of the feed material, treating the feed material in the reaction vessel under conditions of elevated temperature in order to vaporise at least a portion of the feed material to form a vaporised feed material, introducing the vaporised feed material to a fractionating column to form a diesel fraction, removing the diesel fraction from the fractionating column and condensing the diesel fraction to form diesel.

Preferably, the reaction in the reaction vessel is a catalytic depolymerisation process.

The reaction vessel may be of any suitable form. For instance, the reaction vessel may be a tank, sump, reactor or the like. The reaction vessel may be of any suitable volume, although in a preferred embodiment of the invention, the reaction vessel may have a capacity of up to 6000 L. More preferably, the reaction vessel may have a capacity of up to 4000 L. Yet more preferably, the reaction vessel may have a capacity of up to 2000 L. It will be understood that the exact size of the reaction vessel will be dependent on the desired throughput for the process and the availability of the feed material. Thus, the size of reaction vessel may vary depending on these factors, or may be scaled upwardly or downwardly according to the availability of feed material and so on.

In embodiments of the invention in which the reaction vessel receives feed material from the mixing vessel of the first aspect of the invention, it is envisaged that the reaction vessel may be approximately the same volume as the mixing vessel.

In some embodiments of the invention, a plurality of reaction vessels may be provided.

The reaction vessel may be agitated using any suitable technique, such as one or more impellers. More preferably, however, the reaction vessel may be agitated using a recirculating pump. In some embodiments of the invention, the reaction vessel may be provided with one or more impellers in addition to a recirculating pump. It will be understood that the function of a recirculating pump is to extract material from the reaction vessel and then reintroduce it to the reaction vessel to cause agitation of the material within the reaction vessel, thereby forming a substantially homogenous feed material.

Any suitable recirculating pump may be used, although in a preferred embodiment of the invention, the recirculating pump may comprise a high shear mixer. The recirculating pump may extract material from any suitable location within the reaction vessel, although in a preferred embodiment, the recirculating pump may extract material from a lower region of the reaction vessel and reintroduce the extracted material into an upper region of the reaction vessel. In this way, relatively fine, light material that may float to the top of the reaction vessel may be drawn down into the reaction vessel and extracted through the bottom thereof so as to create a relatively homogenous feed material.

The feed material may be introduced to the reaction vessel using any suitable technique. For instance, the feed material may be introduced to the reaction vessel through the recirculating pump. Alternatively, the feed material may simply be pumped into the reaction vessel through one or more pipes.

As previously stated, the reaction vessel is operated at an elevated temperature. Any elevated temperature may be used, although it is envisaged that the elevated temperature may be selected on the basis that the elevated temperature is sufficient to vaporise the diesel component of the feed material. Preferably, the elevated temperature may be adapted to selectively vaporise the diesel content of the feed material.

Any suitable elevated temperature may be used, although in a preferred embodiment of the invention, the elevated temperature may be between about 100° C. and about 600° C. More preferably, the elevated temperature may be between about 120° C. and about 450° C. Still more preferably, the elevated temperature may be between about 140° C. and about 300° C. Yet more preferably, the elevated temperature may be between about 160° C. and about 220° C. Most preferably, the elevated temperature may be between about 180° C. and about 190° C.

The reaction vessel may be maintained at the elevated temperature using any suitable technique. For instance, one or more heat sources (such as burners, heat probes or the like) may be used to maintain the reaction vessel at the elevated temperature. In further embodiments of the invention, the reaction vessel may be provided with a heating and/or cooling system. Any suitable system may be used, although in a particular embodiment of the invention it is envisaged that the reaction vessel may be at least partially surrounded by a jacket through which heating and/or cooling fluid may be circulated so as to control the temperature within the reaction vessel. It is also worth noting that the reaction occurring in the reaction vessel may be exothermic. Thus, once the reaction vessel has reached the desired temperature, a cooling system may be required to maintain the temperature in the reaction vessel at the desired level.

Alternatively, heating and/or cooling fluid may be circulated through one or more pipes or jackets located within the reaction vessel so as to control the temperature therewithin. In this embodiment of the invention, it is envisaged that one or more receptacles (such as one or more tanks etc.) of heating fluid (such as an oil or the like) may be provided, wherein the heating and/or cooling fluid is circulated through one or more pipes from the one or more receptacles through the reaction vessel. In other embodiments of the invention, one or more heating and or cooling devices may be provided in the reaction vessel.

In a preferred embodiment of the invention, heating fluid may be housed in a heating vessel while cooling fluid may be housed in a cooling vessel. The heating vessel may be heated using any suitable technique so as to maintain the heating fluid at a desired temperature. Similarly, the cooling vessel may be cooled using any suitable technique so as to maintain the cooling fluid at a desired temperature.

In another embodiment of the invention, solid material in the feed material may be reduced in size by adding one or more size reduction members at or adjacent the point at which feed material is extracted from the reaction vessel and/or the point at which recirculated feed material is reintroduced to the reaction vessel. Any suitable size reduction members may be provided, such as one or more blades, teeth, grates, disintegrators or the like, or any suitable combination thereof. It is envisaged that the use of a high shear mixer to recirculate the feed material may draw solid material in the reaction vessel into or through the size reduction members with sufficient force so as to cause breakage or disintegration of the solid material upon impact. Indeed, it is envisaged that the use of a high shear mixer may create a vortex within the reaction vessel and assist in forming a substantially homogenous feed material.

The reaction vessel may be an open vessel or may be a closed vessel. In a preferred embodiment of the invention, the reaction vessel is a closed vessel. More preferably, the reaction vessel may be adapted to substantially preclude certain gases from entering the reaction vessel. Specifically, the reaction vessel may be adapted to substantially preclude oxygen from entering the reaction vessel.

It will be understood that the mixing of oxygen with the feed material may be undesirable given that the feed material may comprise, at least in part, biodiesel or similar volatile substances. Mixing of such substances with oxygen may result in fire or an explosion.

In light of the foregoing, the reaction vessel may be provided with an airlock assembly adapted to substantially preclude oxygen from entering the reaction vessel. Any suitable airlock assembly may be used, including one or more valves (for instance, a double gate valve) through which the feed material is added to the reaction vessel. The reaction vessel may be provided with an inert atmosphere (for instance, through the use of an inert gas, such as, but not limited to, nitrogen). In this embodiment of the invention, the pressure inside the reaction vessel may be elevated to greater than atmospheric pressure so as to minimise or preclude the flow of gases into the reaction vessel.

The mixing of the feed material in the reaction vessel may be conducted in the presence of a catalyst. Any suitable catalyst may be used, and it is envisaged that the catalyst may be a liquid catalyst, a solid catalyst, or a combination of the two. The solid catalyst may be of any suitable form, although it is envisaged that the catalyst may comprise a powder. Preferably, the solid catalyst may comprise a strong base, such as (but not limited to) sodium hydroxide, potassium hydroxide, sodium methoxide or the like, or any suitable combination thereof. Alternatively, the solid catalyst may be a silicon-based catalyst or an aluminosilicate, such as a zeolite.

In embodiments of the invention in which the catalyst comprises a liquid, it is preferred that the liquid catalyst comprises, at least in part, an ionic liquid. Any suitable ionic liquid may be used, although it is envisaged that the ionic liquid may include methylimidazolium and/or pyridinium ions. It is envisaged that the ionic liquid may also act as a solvent.

The ionic liquid catalyst may be added by itself or may be mixed with another liquid prior to being introduced to the reaction vessel. Any suitable liquid may be mixed with the ionic liquid, although in a preferred embodiment of the invention, the ionic liquid may be mixed with a hydrocarbon liquid, such as, but not limited to, diesel or biodiesel. The hydrocarbon liquid and the ionic liquid may be mixed in any suitable proportions, and the hydrocarbon liquid may comprise between 1% and 99% of the mixture, while the ionic liquid may comprise between 1% and 99% of the mixture.

It will be understood that the amount of catalyst to be added to the reaction vessel may depend on a number of factors, including the type of material in the feed material, the volume of the feed material and/or the reaction vessel, the type of catalyst, the temperature of the reaction vessel and so on.

It will also be understood that the purpose of the catalyst may be to solubilise the solid material in the feed material through depolymerisation. Thus, as previously stated, the reaction in the reaction vessel preferably comprises a catalytic depolymerisation process.

In an alternative embodiment of the invention, no additional catalyst may be added to the reaction vessel. Instead, the contents of the reaction vessel may consist entirely of the feed material. In this embodiment of the invention, it is envisaged that the feed material may comprise substantially no solids (other than unavoidable trace amounts) meaning that any organic material in the feed material may be substantially solubilised.

In other embodiments of the invention, residual solid particles in the feed material may be removed. This may be done in any suitable manner. For instance, at least a portion of the recirculating stream of feed material may be passed through a filter to remove residual solids prior to recycling the feed material to the reaction vessel. Alternatively, solid material may be periodically removed from the reaction vessel, for instance by syphoning or otherwise removing the solid material from the reaction vessel. The removal of the solid material from the reaction vessel may be conducted periodically at certain predetermined time intervals. Alternatively, the reaction vessel may be provided with one or more sensors (for example, level sensors, density sensors etc.) adapted to determine the amount of solid material in the feed material. When the sensors detect that the quantity of solid material in the feed material reaches a predetermined level, solid material may be removed from the reaction vessel (such as by syphoning, decantation etc.). It is envisaged that the equipment used in the method of the present invention is selected based, amongst other factors, on its ability to operate at elevated temperatures in order to minimise energy wastage required when heating and cooling fluids. This in turn reduces the likelihood of blockages in process lines caused by solid particles falling out of suspension.

It is envisaged that the solid material removed from the reaction vessel may include a quantity of entrained liquid. Thus, in a preferred embodiment of the invention, the removed solid material may be filtered using any suitable filter device, such as, but not limited to, a press, including a belt press. It is envisaged that the liquid recovered from the solid material may be returned to the reaction vessel. The solid material (sludge) may be collected in a vessel, or may be discarded as waste.

In some embodiments of the invention, the reaction vessel may be provided with one or more barriers therein adapted to assist in the collection of solid material. For instance, the reaction vessel may comprise one or more weirs adapted to prevent solid material from entering a reaction zone. It is envisaged that the recirculated feed material may enter a collection zone and that liquid may overflow a weir into a reaction zone within the reaction vessel. The solid material may accumulate in the collection zone and may be substantially precluded from overflowing the weir into the reaction zone.

It is envisaged that the fractionating column may be substantially conventional in design, and no discussion on the operation of the fractionating column is required. However, it is envisaged that, in the present invention, the only fraction recovered from the fractionating column for further use may be the diesel fraction. While other fractions may be formed in the fractionating column, these may either be discarded or may be returned to the reaction vessel for further processing. Any ash formed in the process may also be collected and discarded.

After recovery of the diesel fraction from the fractionating column, it is envisaged that the diesel fraction may be cooled. The diesel fraction recovered from the fractionating column may include water, and in some embodiments of the invention the water may be removed from the diesel using any suitable separation technique. These separation techniques are largely conventional, and no separate discussion of these is required. Typically, however, it is envisaged that the diesel fraction will be substantially free of water in embodiments of the invention in which the feed material is produced by the methods of the first or second aspect wherein the medium used is an ionic liquid or mixture of ionic liquids.

It is also envisaged that the liquid catalyst may be separated from the diesel. The recovered liquid catalyst may be discarded or returned to any suitable part of the process.

The diesel recovered from the fractionating column (or once separated from water, if applicable) may be suitable for immediate use in any suitable application. Alternatively, one or more upgrading techniques may be used to upgrade the diesel to the desired quality.

The diesel may be upgraded using any suitable technique. In a preferred embodiment of the invention, however, the diesel may be upgraded in order to remove at least a portion of the sulphur present in the diesel. The removal of sulphur from the diesel may be achieved using any suitable technique. In a preferred embodiment of the invention, however, at least a portion of the diesel may be introduced to an upgrading vessel.

The upgrading vessel may be of any suitable form. In a preferred embodiment of the invention, however, the upgrading vessel is, in many ways, similar to the mixing vessel mentioned earlier in this specification. Specifically, it is envisaged that the upgrading vessel may be agitated. The upgrading vessel may be of any suitable volume, although in a preferred embodiment of the invention, the upgrading vessel may have a capacity of up to 20,000 L. More preferably, the upgrading vessel may have a capacity of up to 10,000 L. Yet more preferably, the upgrading vessel may have a capacity of up to 5000 L. It will be understood that the exact size of the upgrading vessel will be dependent on the volume of diesel to be upgraded. Thus, the size of upgrading vessel may vary depending on these factors, or may be scaled upwardly or downwardly according to the availability of diesel and so on.

The upgrading vessel may be agitated using any suitable technique, such as one or more impellers. More preferably, however, the upgrading vessel may be agitated using a recirculating pump. In some embodiments of the invention, the upgrading vessel may be provided with one or more impellers in addition to a recirculating pump. It will be understood that the function of a recirculating pump is to extract material from the upgrading vessel and then reintroduce it to the upgrading vessel to cause agitation of the diesel within the upgrading vessel.

Any suitable recirculating pump may be used, although in a preferred embodiment of the invention, the recirculating pump may comprise an inline mixer. The recirculating pump may extract material from any suitable location within the upgrading vessel, although in a preferred embodiment, the recirculating pump may extract material from a lower region of the upgrading vessel and reintroduce the extracted material into an upper region of the upgrading vessel.

The diesel may be introduced to the upgrading vessel using any suitable technique. For instance, the diesel may be introduced to the upgrading vessel through the recirculating pump. Alternatively, the diesel may simply be pumped into the upgrading vessel through one or more pipes.

In some embodiments of the invention, a plurality of upgrading vessels may be provided. The plurality of upgrading vessels may be adapted for operation in series, in parallel, or in a combination of the two.

It is envisaged that the upgrading vessel may contain a medium into which the diesel is introduced. Any suitable medium may be used, although in a preferred embodiment of the invention, the medium may be a liquid medium. In a preferred embodiment of the invention, the liquid medium may consist of one or more ionic liquids. Any suitable ionic liquid may be used, although it is envisaged that the ionic liquid may comprise a liquid organic salt. The ionic liquid may preferably include methylimidazolium and/or pyridinium ions. One specific example of a suitable ionic liquid may be 1-Butyl-3-methylimidazolium chloride.

Preferably, the diesel and the ionic liquid are retained in contact with one another in the upgrading vessel for a period of time. The exact period of time may vary depending on a number of factors (such as the volume of the upgrading vessel, the degree of agitation, the type of ionic liquid used, the sulphur content of the diesel and so on), although it is envisaged that the diesel and the ionic liquid may remain in contact for a sufficient time for one of more of the following to occur: the oxidation of sulphur compounds within the diesel, the extractive removal of sulphur dioxide and/or the extractive removal of organosulphur and/or organonitrogen compounds.

It is envisaged that at least a portion of the sulphur and/or nitrogen in the diesel may be removed from the diesel in the upgrading vessel. The at least a portion of the sulphur and/or nitrogen may be removed in any suitable form. However, in a preferred embodiment of the invention, the at least a portion of the sulphur and/or nitrogen may be removed from the diesel in gaseous form. In a most preferred embodiment of the invention, the at least a portion of the sulphur may be removed in the form of gaseous sulphur dioxide, while the at least a portion of the nitrogen may be removed in the form of NOₓ.

Sulphur and/or nitrogen removed from the diesel may be removed from the upgrading vessel. The sulphur and/or nitrogen may be vented to the atmosphere, or may be collected and/or sequestered using any suitable technique.

In one embodiment of the invention, however, sulphur dioxide removed from the upgrading vessel may be converted into a saleable product. Any suitable saleable product may be provided, although in one embodiment of the invention, the sulphur dioxide may be converted into a fertilizer. In this embodiment of the invention, it is envisaged that the sulphur dioxide may be converted into a fertilizer by contacting the sulphur dioxide with a suitable compound to achieve the conversion. Any suitable compound may be used, although in a preferred embodiment of the invention, the compound may comprise ammonia. The ammonia may be in gaseous or liquid form, or a combination thereof. Ammonia and sulphur dioxide may be brought into contact with one another in any suitable vessel.

It is envisaged that bringing ammonia and sulphur dioxide into contact with one another may result in the formation of ammonia sulphate. The ammonia sulphate may be used by itself as a fertilizer or may be combined with one or more additional compounds and/or substances to form a fertilizer composition.

Preferably, following the removal of sulphur in the upgrading vessel, the diesel remaining has a very low sulphur contents. Thus, following the removal of sulphur, the diesel may be ultra-low-sulphur diesel (ULSD). Specifically, the diesel may have a sulphur content of no more than about 50 ppm. More preferably, the diesel may have a sulphur content of no more than about 25 ppm. Still more preferably, the diesel may have a sulphur content of no more than about 15 ppm. Most preferably, the diesel may have a sulphur content of no more than about 10 ppm.

Preferably, once the at least a portion of the sulphur and/or nitrogen has been removed, the upgrading vessel may be heated to an elevated temperature. Any elevated temperature may be used, although it is envisaged that the elevated temperature may be selected on the basis that diesel within the upgrading vessel may evaporate without simultaneous evaporation of the ionic liquid. Any suitable elevated temperature may be used, although in a preferred embodiment of the invention, the elevated temperature may be between about 100° C. and about 500° C. More preferably, the elevated temperature may be between about 125° C. and about 400° C. Still more preferably, the elevated temperature may be between about 150° C. and about 300° C. Yet more preferably, the elevated temperature may be between about 175° C. and about 250° C. Most preferably, the elevated temperature may be about 200° C.

The upgrading vessel may be maintained at the elevated temperature using any suitable technique. For instance, one or more heat sources (such as burners, heat probes or the like) may be used to maintain the upgrading vessel at the elevated temperature. In further embodiments of the invention, the upgrading vessel may be provided with a heating and/or cooling system. Any suitable system may be used, although in a particular embodiment of the invention it is envisaged that the upgrading vessel may be at least partially surrounded by a jacket through which heating and/or cooling fluid may be circulated so as to control the temperature within the upgrading vessel. Alternatively, heating and/or cooling fluid may be circulated through one or more pipes or jackets located within the upgrading vessel so as to control the temperature therewithin.

It is envisaged that, at the elevated temperature, the diesel may evaporate from the ionic liquid. The diesel may be removed from the upgrading vessel using any suitable technique. Preferably, the evaporated diesel is introduced to a condenser, at which point the gaseous diesel is returned to a liquid state.

In an alternative embodiment of the invention, the mixture of ionic liquid and low-sulphur diesel may be treated using any suitable technique to separate the diesel from the ionic liquid. For instance, the diesel and the ionic liquid may be transferred to a separator (such as, but not limited to, a low pressure separator). It is envisaged that, in the separator, the ionic liquid and the diesel may be separated from one another.

The upgrading vessel may be an open vessel or may be a closed vessel. In a preferred embodiment of the invention, the upgrading vessel is a closed vessel. More preferably, the upgrading vessel may be adapted to substantially preclude certain gases from entering the upgrading vessel. Specifically, the upgrading vessel may be adapted to substantially preclude oxygen from entering the mixing vessel. It will be understood that the mixing of oxygen with the diesel may be undesirable as it may result in fire or an explosion.

In light of the foregoing, the upgrading vessel may be provided with an airlock assembly adapted to substantially preclude oxygen from entering the upgrading vessel. Any suitable airlock assembly may be required, including one or more valves (for instance, a double gate valve) through which the diesel is added to the upgrading vessel. The upgrading vessel may be provided with an inert atmosphere (for instance, through the use of an inert gas, such as, but not limited to, nitrogen). In this embodiment of the invention, the pressure inside the upgrading vessel may be elevated to greater than atmospheric pressure so as to minimise or preclude the flow of gases into the upgrading vessel.

Following the evaporation of the diesel from the ionic liquid, further diesel may be introduced into the upgrading vessel and the sulphur removal process may be repeated. Alternatively, prior to the introduction of further diesel, the ionic liquid (which may still contain impurities, including sulphur-containing compounds and/or nitrogen-containing compounds) may be regenerated through the removal of the impurities. The impurities may be removed using any suitable technique, although in a preferred embodiment of the invention, the ionic liquid may be heated in a vessel (and particularly a vessel under a vacuum) so as to vaporize and separate any impurities from the ionic liquid. The ionic liquid may then be returned to any suitable location within the process.

It is envisaged that, in embodiments of the invention in which the intermediate feedstock streams are blended to create a relatively low sulphur feed material, the diesel produced by the method of the present invention may have very low sulphur contents. Thus, the diesel may be ultra-low-sulphur diesel (ULSD). Specifically, the diesel may have a sulphur content of no more than 50 ppm. More preferably, the diesel may have a sulphur content of no more than 25 ppm. Still more preferably, the diesel may have a sulphur content of no more than 15 ppm. Most preferably, the diesel may have a sulphur content of no more than 10 ppm.

The method may produce any suitable quantity of diesel. For instance, it is envisaged that the method may produce at least 1000 L/hr of diesel. More preferably, the method may produce at least 2000 L/hr of diesel. Yet more preferably, the method may produce at least 3000 L/hr of diesel. Still more preferably, the method may produce at least 4000 L/hr of diesel.

Preferably, the diesel produced by the method comprises synthetic diesel, and, more preferably, renewable synthetic diesel.

In a fourth aspect, the invention resides broadly in a method for the removal of sulphur and/or nitrogen from diesel, the method comprising the steps of introducing diesel containing sulphur and/or nitrogen into a vessel containing one or more ionic liquids, and contacting the one or more ionic liquids and the diesel such that at least a portion of the sulphur and/or nitrogen in the diesel is separated therefrom.

In a fifth aspect, the invention resides broadly in a method for the production of diesel, the method comprising forming a feed material according to the first aspect of the invention and forming diesel from the feed material according to the third aspect of the invention.

In a sixth aspect, the invention resides broadly in a method for the production of diesel, the method comprising forming a feed material according to the second aspect of the invention and forming diesel from the feed material according to the third aspect of the invention.

In a seventh aspect, the invention resides broadly in a method for the production of low-sulphur diesel, the method comprising forming a feed material according to the first aspect of the invention, forming diesel from the feed material according to the third aspect of the invention and removing at least a portion of the sulphur from the diesel according to the fourth aspect of the invention.

In an eighth aspect, the invention resides broadly in a method for the production of low-sulphur diesel, the method comprising forming a feed material according to the second aspect of the invention, forming diesel from the feed material according to the third aspect of the invention and removing at least a portion of the sulphur from the diesel according to the fourth aspect of the invention.

In a preferred embodiment of the invention, the catalytic depolymerisation method may be operated on a continuous basis. The continuous operation of the catalytic depolymerisation method is advantageous in that in minimises or eliminates blockages in process lines that occur in batch processes. These blockages occur, for instance, when solid particles drop out of suspension.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a flowsheet of a feedstock sorting process according to an embodiment of the present invention.

FIG. 2 illustrates a flowsheet of a method for the production of diesel according to an embodiment of the present invention.

FIG. 3 illustrates a cutaway view of a process vessel according to an embodiment of the present invention.

FIG. 4 illustrates a cross-sectional view of a process vessel according to an embodiment of the present invention.

FIG. 5 illustrates a device for the addition of catalyst to a process stream according to an embodiment of the present invention.

FIG. 6 illustrates a flowsheet of a method for the production of diesel according to an alternative embodiment of the present invention.

FIG. 7 illustrates a flowsheet of a method for the removal of sulphur from diesel according to an embodiment of the present invention.

### DESCRIPTION OF EMBODIMENTS

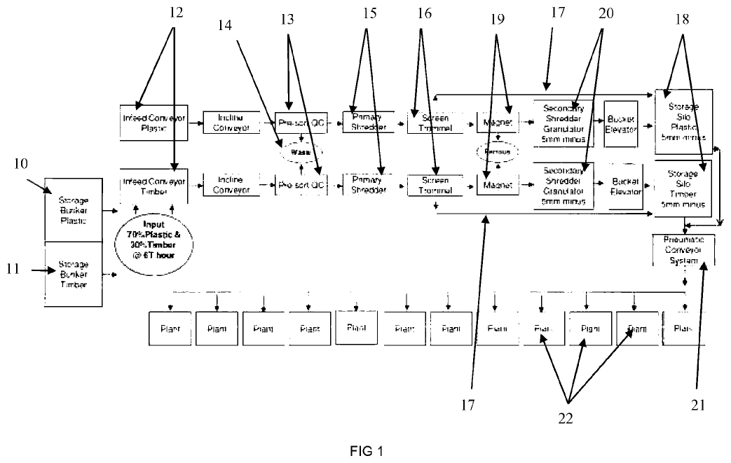

In FIG. 1 a flowsheet of a feedstock sorting process according to an embodiment of the present invention is illustrated. The feedstock sorting process is adapted to prepare two or more feedstock streams for use in the preparation of feed material for a catalytic depolymerisation process.

In FIG. 1, feedstock in the form of polymeric materials (plastic, tyres, rubber and so on) is stored in a polymeric material storage bunker 10, while feedstock in the form of biomass (timber and other vegetation-based matter) is stored in a biomass storage bunker 11. Material from the storage bunkers 10, 11 is transferred by conveyors 12 (in a ratio of 70% polymeric materials to 30% biomass and at a throughput of 6 tonnes/hour) to a pre-sorting process 13 where waste 14 (for instance, in the form of glass, rock and other non-treatable waste) is removed from the feedstock. The remaining feedstock is subject to a size reduction process in shredders 15 after which the shredded feedstock is screened using a trommel 16 having 5 mm apertures.

Undersize streams 17 of particles of less than 5 mm that pass through the trommel 16 are transferred to feedstock stream storage silos 18, while oversize streams of particles of over 5 mm are brought into close proximity to magnets 19 in order to removed magnetic impurities (especially ferrous impurities).

Following the removal of magnetic impurities, the oversize streams are again subject to a size reduction process in shredders 20 to reduce the size of the particles in the oversize streams to below 5 mm. The oversize feedstock streams are then combined with the undersize feedstock streams in the storage silos 18. It is envisaged that the silos 18 may be sized so as to hold sufficient material to allow the processing plant to keep operating for a period of time, even in the event of an interruption to the supply of feedstock. Preferably, the silos 18 hold sufficient material so that the processing plant could continue to operate for at least two weeks should an interruption to the supply of feedstock occur.

Given that it is desirable to store material in the silos 18 for a period of time, the minimisation of fine material in the feedstock streams is also desirable due to the possibility of self-combustion. Thus, it is preferred that the majority of the particles in the feedstock streams are greater than 5 mm in size. In a particular embodiment, the average particle size in the feedstock streams may be about 50 mm.

From the storage silos 18, the feedstock streams are transferred via a pneumatic conveyor system 21 to a plurality of process vessels 22.

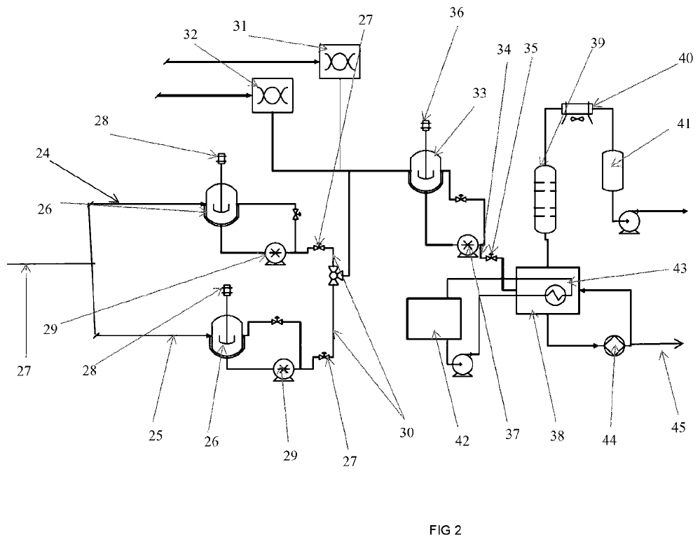

In FIG. 2 a flowsheet of a method for the production of diesel according to an embodiment of the present invention is illustrated. Feedstock 23 is split (using the flowsheet of FIG. 1) into a polymeric material feedstock stream 24 and a biomass feedstock stream 25. Each feedstock stream 24, 25 is introduced into a process vessel 26. The process vessels are sealed with airlock gates 27 and are maintained with a nitrogen atmosphere so as to prevent oxygen from entering the process vessels 26. Each process vessel 26 is maintained at a temperature of 180° C. in order to increase the solubility of the solid particles in the feedstock streams 24, 25 in the carrier oil (in this embodiment, biodiesel) in the process vessels 26.

The process vessels 26 are agitated using impellers 28, although further agitation is provided using inline mixers 29 that extract material from a lower region of the process vessels 26 and return it to an upper region of the process vessels 26. The inline mixers 29 exert high degrees of suction on the feedstock streams 24, 25 such that even fine, light particles floating on the surface of the liquid in the process vessels 26 are drawn through the inline mixers 29. The high shear conditions created by the inline mixers 29 (along with the elevated temperatures in the process vessels 26) serve to further reduce the size of particles in the feedstock streams 24, 25 and also to form substantially homogenous intermediate feedstock streams 30 that exit the process vessels 26.

Catalyst 31 in the form of fine, solid faujasite is added to the process vessels 26, while lime 32 is also added in order to raise the pH of the intermediate feedstock streams 30 to between about 8 and 12.

Once sufficient solubilisation of the feedstock streams 24, 25 has occurred so that the intermediate feedstock streams 30 have been formed in the process vessels 26, the intermediate feedstock streams 30 may be introduced to a mixing vessel 33 where the intermediate feedstock streams 30 are combined to form the feed material 34.

As with the process vessels 26, the mixing vessel 33 is sealed with an airlock gate 35 and is maintained with a nitrogen atmosphere so as to prevent oxygen from entering the mixing vessel 33. The mixing vessel 33 is maintained at a temperature of 180° C. in order to increase the solubility of the solid particles in the intermediate feedstock streams 30 in the carrier oil (in this embodiment, biodiesel) in the mixing vessel 33.

The mixing vessel 33 is agitated using an impeller 36, although further agitation is provided using an inline mixer 37 that extracts material from a lower region of the mixing vessel 33 and returns it to an upper region of the mixing vessel 33. The inline mixer 37 exerts high degrees of suction on the intermediate feedstock streams 30 such that even fine, light particles floating on the surface of the liquid in the mixing vessel 33 are drawn through the inline mixer 37. The high shear conditions created by the inline mixer 37 (along with the elevated temperatures in the mixing vessel 33) serve to further reduce the size of particles in the intermediate feedstock streams 30 and also to form a substantially homogenous feed material 34 that exits the mixing vessel 33. In addition, the high shear conditions enhance even dispersal of the catalyst and lime in the intermediate feedstock streams, thereby increasing the speed of the reaction.

Catalyst 31 in the form of fine, solid faujasite is added to the mixing vessel 33, while lime 32 is also added in order to maintain the pH of the feed material 34 at between about 8 and 12.

Once a substantially homogenous feed material 34 is formed in the mixing vessel 33, the feed material 34 is introduced to a reaction vessel 38. The reaction vessel 38 is maintained with a nitrogen atmosphere so as to prevent oxygen from entering the reaction vessel 38. The reaction vessel 38 is maintained at a temperature of 280° C. in order to both assist in the catalytic depolymerisation reaction occurring in the reaction vessel 38 and to vaporise at least a portion of the feed material 34 (preferably at least the diesel fraction of the feed material 34), with the vaporised portion of the feed material 34 entering a fractionating column 39 for recovery of the diesel fraction. Water is also recovered in the fractionating column 39.

The recovered diesel and water is condensed using a cooler 40, and then the diesel may be separated from the water using a separator 41. The recovered diesel may then either be used or may be treated to upgrade the quality of the diesel.

The temperature in the reaction vessel 38 is maintained by providing a hot oil tank 42 that circulates hot oil through pipes 43 in the reaction vessel 38. In this way, the temperature of the feed material 34 in the reaction vessel 38 may be maintained at a substantially constant temperature, thereby ensuring a consistent reaction rate within the reaction vessel 38.

The reaction vessel 38 is associated with a high shear mixer 44 that extracts feed material 34 from a lower region of the reaction vessel 38 and returns it to an upper region of the reaction vessel 38. The high shear mixer 44 assists in ensuring that the feed material 34 remains a substantially homogenous mixture and that the catalyst 31 in the feed material 34 is substantially evenly distributed throughout the feed material 34, in order to ensure high reaction efficiency.

Periodically, feed material 34 circulating through the high shear mixer 44 may be diverted to a sludge separation process. This diverted feed material 45 is subjected to a separation step (using a decanter) in which sludge from the reaction vessel 38 is separated from diesel.

Diesel separated from the sludge is returned to the reaction vessel 38, while the sludge is filtered using a belt press (not shown). Diesel recovered from the belt press is also returned to the reaction vessel 38.

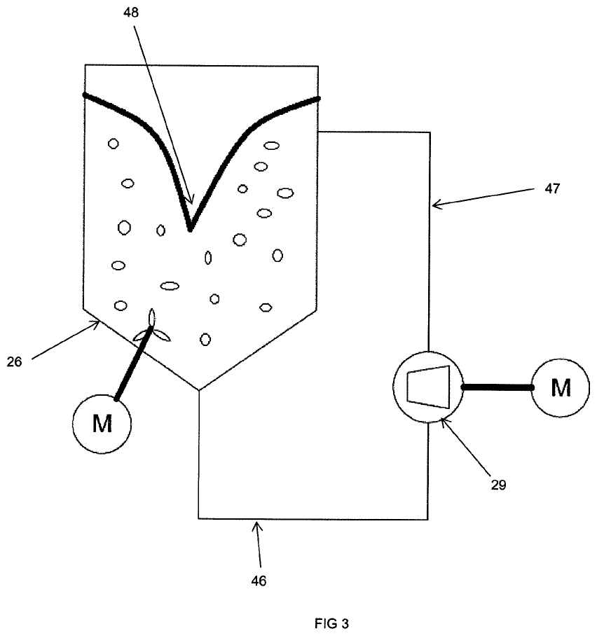

FIG. 3 illustrates a cutaway view of a process vessel 26 according to an embodiment of the present invention. In this embodiment of the invention, the process vessel 26 is agitated using an inline mixer 29 that extracts the feedstock stream in the process vessel 26 from a lower region of the process vessel 26 through pipe 46 and returns it through pipe 47 to an upper region of the process vessel 26.

It will be seen in FIG. 3 that the high suction created by the inline mixer 29 creates a vortex 48 within the feedstock stream, thereby ensuring that a substantially homogenous mixture is formed within the process vessel 26.

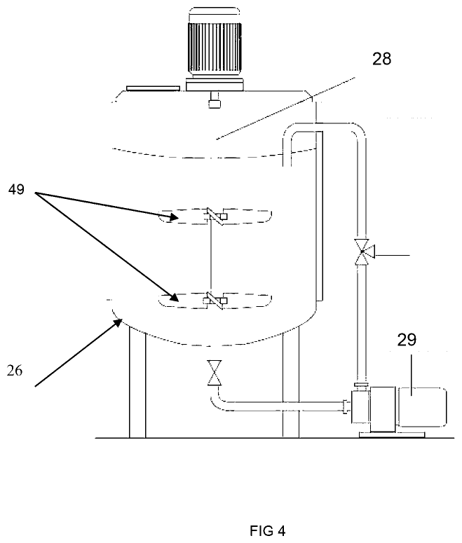

FIG. 4 illustrates a cross-sectional view of a process vessel 26 according to an embodiment of the present invention. The process vessel 26 of FIG. 4 is similar to that of FIG. 3 except that, in addition to the inline mixer 29, the process vessel 26 includes an impeller 28 adapted to further mix the feedstock material and also to reduce the size of solid particles in the feedstock material upon contact with the blades 49.

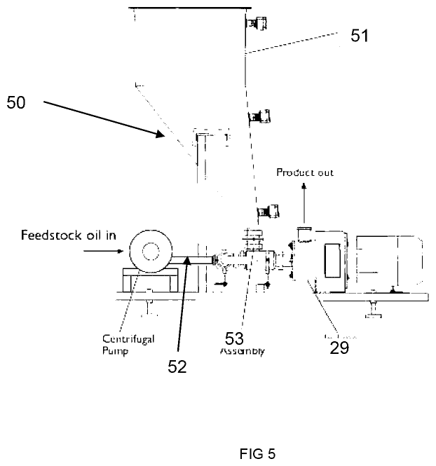

FIG. 5 illustrates a device 50 for the addition of catalyst to a process stream according to an embodiment of the present invention. The device 50 comprises a hopper 51 for holding solid catalyst, with the hopper 51 being in fluid communication with a pipe 52 through which a process stream extracted from a process vessel, mixing vessel or reaction vessel is circulated under the suction created by the inline mixer 29.

Catalyst from the hopper 51 is drawn into the circulating process stream through a Venturi assembly 53. The mixing conditions created by the inline mixer 29 ensure that the catalyst is dispersed evenly in the process stream, thereby forming a substantially homogenous process stream.

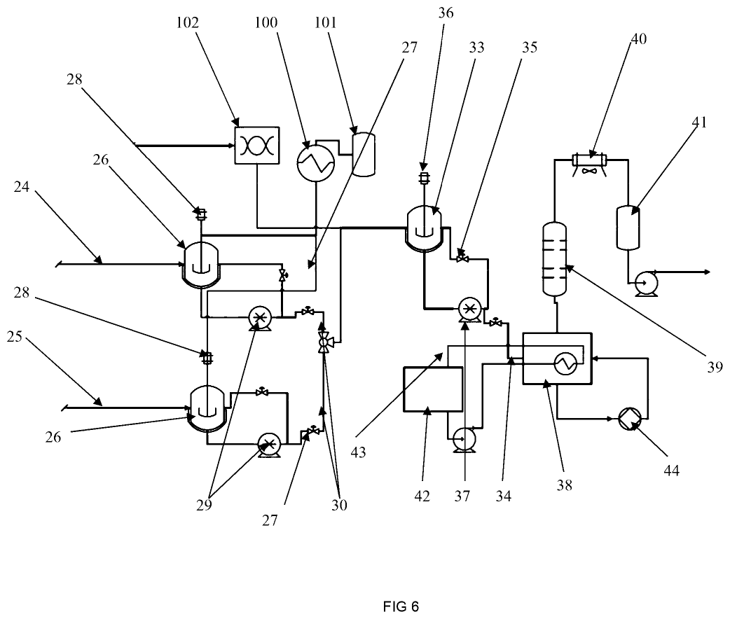

In FIG. 6 an alternative flowsheet of a method for the production of diesel according to an embodiment of the present invention is illustrated. Feedstock is split into a polymeric material feedstock stream 24 and a biomass feedstock stream 25. Each feedstock stream 24, 25 is introduced into a process vessel 26. The process vessels are sealed with airlock gates 27 and are maintained with a nitrogen atmosphere so as to prevent oxygen from entering the process vessels 26. Each process vessel 26 is maintained at a temperature of 110° C. in order to increase the solubility of the solid particles in the feedstock streams 24, 25 in the medium in the process vessels 26. In this embodiment of the invention, the medium is an ionic liquid, particularly 1-Butyl-3-methylimidazolium chloride.

The elevated temperature in the process vessels 26 may be maintained using burners, heated jackets or the like. However, in the embodiment of the invention illustrated in FIG. 6, the elevated temperature in the process vessels 26 may initially be achieved using heating apparatus (not shown), however the elevated temperature may be substantially maintained by the fact that the reaction occurring in the process vessels 26 is exothermic. The heating apparatus (not shown) may be periodically used in order to maintain the elevated temperature in the process vessels 26 if the heat generated by the exothermic reaction is insufficient by itself to maintain the elevated temperature.

In the embodiment of the invention shown in FIG. 6, the elevated temperature within the process vessels 26 results in the evaporation of water contained in the feedstock streams 24, 25. The evaporated water is removed from the process vessels 26 in the form of steam, is passed through a condenser 100 and is then collected in a tank 101.

The process vessels 26 are agitated using impellers 28, although further agitation is provided using inline mixers 29 that extract material from a lower region of the process vessels 26 and return it to an upper region of the process vessels 26. The inline mixers 29 exert high degrees of suction on the feedstock streams 24, 25 such that even fine, light particles floating on the surface of the liquid in the process vessels 26 are drawn through the inline mixers 29. The high shear conditions created by the inline mixers 29 (along with the elevated temperatures in the process vessels 26) serve to further reduce the size of particles in the feedstock streams 24, 25 and also to form substantially homogenous intermediate feedstock streams 30 that exit the process vessels 26.

The ionic liquid in the process vessels 26 serves as both a catalyst and a solvent, and organic compounds within the feedstock streams 24, 25 are, over a period of time depending on the type of material in the feedstock streams 24, 25) solubilized or dissolved into the ionic liquid.

It is envisaged that metallic matter may be present in the plastics feedstock stream 24. It is envisaged that, in this embodiment of the invention, the metallic matter will not be dissolved or solubilized by the ionic liquid, and will instead settle or precipitate to the bottom of the process vessel 26 (due to the difference in density between the metallic matter and the ionic liquid) where it will form a metallic sludge (not shown). This metallic sludge will be collected from the process vessel 26 and treated in order to recover the metallic matter (and particularly precious metals as found in printed circuit boards and similar devices).

Once sufficient solubilisation of the feedstock streams 24, 25 has occurred so that the intermediate feedstock streams 30 have been formed in the process vessels 26, the intermediate feedstock streams 30 may be introduced to a mixing vessel 33 where the intermediate feedstock streams 30 are combined to form the feed material 34.

In the embodiment of the invention illustrated in FIG. 6, the feed material 34 contains no more than 30% solids. More preferably, however, the feed material contains substantially no solids (other than unavoidable trace amounts). By minimizing the quantity of solid particles in the feed material, clogging of pipework in the plant by settling or deposited solids may be reduced or eliminated.

As with the process vessels 26, the mixing vessel 33 is sealed with an airlock gate 35 and is maintained with a nitrogen atmosphere so as to prevent oxygen from entering the mixing vessel 33. The mixing vessel 33 is maintained at a temperature of 110° C. in order to increase the solubility of the solid particles in the intermediate feedstock streams 30 in the carrier oil (in this embodiment, biodiesel) in the mixing vessel 33.

The mixing vessel 33 is agitated using an impeller 36, although further agitation is provided using an inline mixer 37 that extracts material from a lower region of the mixing vessel 33 and returns it to an upper region of the mixing vessel 33. The inline mixer 37 exerts high degrees of suction on the intermediate feedstock streams 30 such that even fine, light particles floating on the surface of the liquid in the mixing vessel 33 are drawn through the inline mixer 37. The high shear conditions created by the inline mixer 37 (along with the elevated temperature in the mixing vessel 33) serve to further reduce the size of particles (if any) in the intermediate feedstock streams 30 and also to form a substantially homogenous feed material 34 that exits the mixing vessel 33.

If required, additional ionic liquid and/or lime may be added to the mixing vessel 33 through feeder 102.

Once a substantially homogenous feed material 34 is formed in the mixing vessel 33, the feed material 34 is introduced to a reaction vessel 38. The reaction vessel 38 is maintained with a nitrogen atmosphere so as to prevent oxygen from entering the reaction vessel 38. The reaction vessel 38 is maintained at a temperature of 180° C. in order to both assist in the catalytic depolymerisation reaction occurring in the reaction vessel 38 and to vaporise at least a portion of the feed material 34 (preferably at least the diesel fraction of the feed material 34), with the vaporised portion of the feed material 34 entering a fractionating column 39 for recovery of the diesel fraction. If present, water is also recovered in the fractionating column 39.

The recovered diesel (and water if present) is condensed using a cooler 40, and then the diesel may be separated from the water using a separator 41. The recovered diesel may then either be used or may be treated to upgrade the quality of the diesel.

The temperature in the reaction vessel 38 is maintained by providing a hot oil tank 42 that circulates hot oil through pipes 43 in the reaction vessel 38. In this way, the temperature of the feed material 34 in the reaction vessel 38 may be maintained at a substantially constant temperature, thereby ensuring a consistent reaction rate within the reaction vessel 38.

The reaction vessel 38 is associated with a high shear mixer 44 that extracts feed material 34 from a lower region of the reaction vessel 38 and returns it to an upper region of the reaction vessel 38. The high shear mixer 44 assists in ensuring that the feed material 34 remains a substantially homogenous mixture.

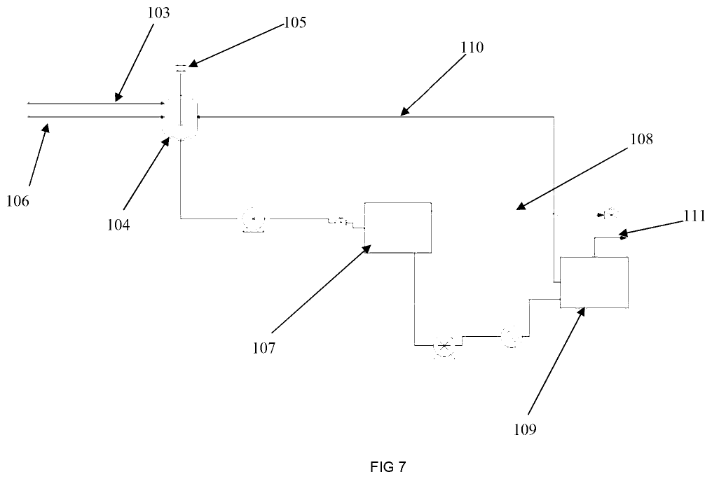

As mentioned previously, diesel recovered from the fractionating column 39 may be treated in order to upgrade the quality of the diesel. In one embodiment, the diesel may be treated according to the flowsheet for removing sulphur from diesel as illustrated in FIG. 7.

In FIG. 7, ionic liquid 103 in the form of 1-Butyl-3-methylimidazolium chloride is added to an upgrading vessel 104. The upgrading vessel 104 is agitated using an impeller 105.

Diesel 106 is introduced to the upgrading vessel 104 and is maintained in contact with the ionic liquid 103 for a period of time (typically at least one hour, although this will depend on the size of the upgrading vessel, the sulphur content of the diesel and so on). It is envisaged that contact between the ionic liquid 103 and the diesel 106 will result in at least a portion of sulphur (and/or nitrogen) in the diesel 106 being converted into gaseous sulphur dioxide (and/or NOₓ). These gaseous compounds are collected as they exit the upgrading vessel 104 and, at least in the case of sulphur dioxide, are converted into a saleable product. In particular, sulphur dioxide may be converted into a fertilizer by contacting the sulphur dioxide with ammonia so as to form ammonium sulphate.

In addition to the removal of gaseous sulphur dioxide (and/or NOₓ), the contact between the ionic liquid 103 and the diesel results in the extraction of sulphur (in the form of sulphur oxide) and organosulphgur (and/or organonitrogen) compounds from the diesel 106 into the ionic liquid 103.

Following the removal of the sulphur and/or nitrogen compounds from the diesel 106, the mixture of ionic liquid 103 and diesel 106 is transferred from the upgrading vessel 104 to a separation tank 107, where it is heated to an elevated temperature of approximately 200° C. using burners, heated jackets or the like. The elevated temperature has the effect of selectively evaporating the diesel 106 from the ionic liquid 103. Evaporated diesel 108 is then collected and condensed. Ideally, the resulting diesel product will have a sulphur content of no more than 10 ppm.

Following the removal of diesel 108, the ionic liquid 103 is transferred to a regeneration vessel 109 in which the ionic liquid 103 is heated under vacuum to vaporize any remaining sulphur and/or nitrogen compounds 111, which are then removed from the regeneration vessel 108. Regenerated ionic fluid 110 is then returned to the upgrading vessel 104 for further use.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for preparing feed material for a catalytic depolymerisation process, the method comprising the steps of:
separating feedstock into two or more feedstock streams based on one or more properties of the feedstock,
introducing each of the two or more feedstock streams into one or more process vessels,
processing the feedstock streams in the presence of a catalyst in the process vessels under conditions of elevated temperature in order to produce two or more intermediate feedstock streams, and
blending the two or more intermediate feedstock streams to form the feed material.

2. A method according to claim 1 wherein the one or more properties of the feedstock include the type of material in the feedstock.

3. A method according to claim 1 wherein the feedstock streams include a biomass feedstock stream and a polymeric material feedstock stream.

4. A method according to claim 1 wherein each of the feedstock streams is subject to a size reduction process prior to being introduced to the one or more process vessels.

5. A method according to claim 4 wherein particles exiting the size reduction process are separated on the basis of particle size, with particles below a predetermined particle size being introduced to the one or more process vessels.

6. A method according to claim 5 wherein the particles introduced to the process vessels have a particle size of between about 20 mm and about 1000 mm.

7. A method according to claim 1 wherein the elevated temperature in the process vessels is between about 160° C. and about 200° C.

8. A method according to claim 1 wherein the feedstock streams are introduced to the process vessels in the presence of a medium heated to the elevated temperature.

9. A method according to claim 8 wherein the medium is a carrier oil in the form of a mineral oil, a vegetable oil or a petroleum oil.

10. A method according to claim 1 wherein the catalytic depolymerisation process is conducted in the presence of a catalyst, the catalyst comprising a liquid catalyst.

11. A method according to claim 10 wherein the liquid catalyst comprises an ionic liquid catalyst.

12. A method according to claim 11 wherein the ionic liquid catalyst comprises methylimidazolium and/or pyridinium ions.

13. A method according to claim 1 wherein the pH in the process vessels is maintained in the range of between 8 and 12.

14. A method according to claim 1 wherein the one or more process vessels are agitated using one or more recirculating pumps.

15. A method according to claim 1 wherein each of the two or more intermediate feedstock streams are substantially homogenous.

16. A method according to claim 1 wherein each of the two or more intermediate feedstock streams comprise between about 25% and 35% solids.

17. A method according to claim 16 wherein the solids in the intermediate feedstock streams are no larger than about 2.5 mm.

18. A method according to claim 3 wherein the biomass feedstock stream forms a biomass intermediate feedstock stream and the polymeric feedstock stream forms a polymeric intermediate feedstock stream.

19. A method according to claim 18 wherein the intermediate feedstock streams are blended in a ratio of the polymeric intermediate feedstock stream to the biomass intermediate feedstock stream of between about 75:25 to 35:65.

20. A method for preparing feed material for a catalytic depolymerisation process, the method comprising the steps of:
introducing a feedstock stream into a process vessel,
processing the feedstock stream in the presence of a medium in the process vessel consisting of an ionic liquid or mixture of ionic liquid in order to produce the feed material.

21. A method according to claim 20 wherein the ionic liquid or mixture of ionic liquids comprises methylimidazolium and/or pyridinium ions.

22. A method according to claim 20 wherein the ionic liquid is 1-Butyl-3-methylimidazolium chloride.

23. A method according to claim 20 wherein the process vessel is operated at an elevated temperature.

24. A method according to claim 23 wherein the elevated temperature is between about 100° C. and about 140° C.

25. A method for the production of diesel comprising the steps of:
introducing a feed material into a reaction vessel, the reaction vessel being associated with one or more agitation devices adapted to agitate the feed material so as to ensure the substantial homogeneity of the feed material,
treating the feed material in the reaction vessel under conditions of elevated temperature in order to vaporise at least a portion of the feed material to form a vaporised feed material,
introducing the vaporised feed material to a fractionating column to form a diesel fraction,
removing the diesel fraction from the fractionating column and
condensing the diesel fraction to form diesel, and
wherein the method is operated on a continuous basis.

26. A method according to claim 25 wherein a reaction occurring in the reaction vessel is a catalytic depolymerisation process.

27. A method according to claim 26 wherein the catalytic depolymerisation process is conducted in the presence of a catalyst, the catalyst comprising a liquid catalyst.

28. A method according to claim 27 wherein the liquid catalyst comprises an ionic liquid catalyst.

29. A method according to claim 28 wherein the ionic liquid catalyst comprises methylimidazolium and/or pyridinium ions.

30. A method according to claim 25 wherein the elevated temperature in the reaction vessel is between about 160° C. and about 220° C.

31. A method according to claim 25 wherein the reaction vessel is adapted to substantially preclude oxygen from entering the reaction vessel.

32. A method according to claim 25 wherein the one or more agitation devices comprise one or more recirculating pumps.

33. A method according to claim 25 wherein the diesel has a sulphur content of no more than 15 ppm.

34. A method for the removal of sulphur and/or nitrogen from diesel, the method comprising the steps of
introducing diesel containing sulphur and/or nitrogen into a vessel containing one or more ionic liquids, and
contacting the one or more ionic liquids and the diesel such that at least a portion of the sulphur and/or nitrogen in the diesel is separated therefrom.

35. A method according to claim 34 wherein the at least a portion of the sulphur is removed from the diesel in the form of gaseous sulphur dioxide.

36. A method according to claim 34 wherein, following sufficient contact between the one or more ionic liquids and the diesel, the ionic liquid and the diesel are heated to an elevated temperature to selectively evaporate the diesel from the ionic liquid.

37. A method according to claim 36 wherein the elevated temperature is approximately 200° C.

38. A method according to claim 34 wherein the ionic liquid comprises methylimidazolium and/or pyridinium ions.

39. A method for the production of diesel, the method comprising:
forming a feed material according to the method of claim 1; and
forming diesel from the feed material, the method for forming diesel from the feed material comprising:
introducing a feed material into a reaction vessel, the reaction vessel being associated with one or more agitation devices adapted to agitate the feed material so as to ensure the substantial homogeneity of the feed material,
treating the feed material in the reaction vessel under conditions of elevated temperature in order to vaporise at least a portion of the feed material to form a vaporised feed material,
introducing the vaporised feed material to a fractionating column to form a diesel fraction,
removing the diesel fraction from the fractionating column and
condensing the diesel fraction to form diesel, and
wherein the method is operated on a continuous basis.

40. A method for the production of diesel, the method comprising
forming a feed material according to the method of claim 20; the method for forming the feed material comprising: and
forming diesel from the feed material according to the method, the method of forming the diesel from the feed material comprising:
introducing a feed material into a reaction vessel, the reaction vessel being associated with one or more agitation devices adapted to agitate the feed material so as to ensure the substantial homogeneity of the feed material,
treating the feed material in the reaction vessel under conditions of elevated temperature in order to vaporise at least a portion of the feed material to form a vaporised feed material,
introducing the vaporised feed material to a fractionating column to form a diesel fraction,
removing the diesel fraction from the fractionating column and
condensing the diesel fraction to form diesel, and
wherein the method is operated on a continuous basis.

41. The method according to claim 39, further comprising removing at least a portion of sulphur in the diesel by:
introducing diesel containing sulphur and/or nitrogen into a vessel containing one or more ionic liquids, and
contacting the one or more ionic liquids and the diesel such that at least a portion of the sulphur and/or nitrogen in the diesel is separated therefrom.

42. The method according to claim 40, further comprising removing at least a portion of sulphur in the diesel by:
introducing diesel containing sulphur and/or nitrogen into a vessel containing one or more ionic liquids, and
contacting the one or more ionic liquids and the diesel such that at least a portion of the sulphur and/or nitrogen in the diesel is separated therefrom.
